(19) United States
(12) Patent Application Publication
(10) Pub. No.: US 2023/0214673 A1
(43) Pub. Date: Jul. 6, 2023

(54) PREPROCESSING DEVICE AND METHOD FOR INCREMENTAL LEARNING OF CLASSIFIER WITH VARYING FEATURE SPACE

(71) Applicant: ELECTRONICS AND TELECOMMUNICATIONS RESEARCH INSTITUTE, Daejeon (KR)

(72) Inventors: Jung Hoon LEE, Daejeon (KR); Cheol Ho KIM, Daejeon (KR)

(21) Appl. No.: 17/938,018

(22) Filed: Oct. 4, 2022

(30) Foreign Application Priority Data
Jan. 5, 2022 (KR) 10-2022-0001720

(51) Int. Cl. G06N 5/02

(52) U.S. Cl. CPC G06N 5/022

(57) ABSTRACT

Provided are a preprocessing device and method for learning data of a classifier for improving stability and robustness of learning and prediction of a classifier in a varying feature space. The preprocessing device for learning data of a classifier according to the present invention includes a variable spatial information extractor configured to receive data for learning of the classifier, calculate an appearance frequency of each variable combination based on the data, and calculate a cumulative appearance frequency of each variable combination by cumulating and summing the appearance frequency of each variable combination, and a data preprocessor configured to generate a prediction variable—target variable frequency matrix based on the appearance frequencies of each variable combination, apply Laplace smoothing to the frequency matrix according to the cumulative appearance frequency to calculate a probability value of each variable combination, and provide the probability value of each variable combination to the classifier.

### CROSS-REFERENCE TO RELATED APPLICATION

This application claims priority to and the benefit of Korean Patent Application No. 10-2022-0001720, filed on Jan. 5, 2022, the disclosure of which is incorporated herein by reference in its entirety.

### BACKGROUND

### 1. Field of the Invention

The present invention relates to a preprocessing device and method for improving stability and robustness of learning and prediction of a classifier with a varying feature space.

### 2. Discussion of Related Art

A classifier is a representative supervised learning technology that is widely used in various fields such as medical care, Internet of Things (IoT), and smart factories. In general, in order to obtain a classifier, after dividing labeled data into learning data and test data, the learning data is used for learning of a classifier model, and the test data is used for performance evaluation of the learned classifier model.

In this case, when inappropriate data is used, various problems that are unfavorable to learning occur. For example, discontinuities in input data cause non-differentiability and noise problems, and a value of 0 causes numerical errors in a calculation process. In addition, in general, since the amount of data is finite, a kind of bias exists in the learning data, which causes overfitting in which the classifier shows high performance only on the learning data. Therefore, in order to obtain the high-quality classifier, a classification algorithm itself is important, but auxiliary preprocessing techniques that may compensate for various imperfections in the data are also very important.

Accordingly, various preprocessing methods have been proposed. For example, normalization may be used to scale data values, and a Laplace smoothing technique may be used to avoid numerical errors due to zero or interference of noise due to discontinuity. Mean values or k-Nearest Neighbors (kNN) algorithms may be used to resolve missing values. For the overfitting problem, a dropout technique of arbitrarily deactivating some weights, which is frequently used in the field of artificial neural networks (ANN), is effective.

However, most of the above-described techniques have been proposed for the purpose of alleviating imperfections that already exist in given batch data in a fixed variable space, and do not solve unique problems of incremental learning in a varying feature space, which is important in terms of privacy protection, real-time learning, and computing efficiency.

For example, in the incremental learning in the varying feature spaces, the variable space input to the classifier may be biased. This causes a bias problem between a variable space of specific input data and the entire variable space independently of the bias problem between a population distribution and the learning data and between the test data and the learning data that exist in the general learning, and as a result, a classifier that works well only in a specific space is produced. In addition, since the number of variables participating in the learning of the classifier is not constant, the change in scale of the input data is large, making it difficult for classifier parameters to converge. Finally, the bias of the variable space makes the number of times actually participated in learning different of each variable. When this situation is not properly reflected, a problem arises in processing unstable variables like stable variables.

Of course, several regularization terms that may be added to an objective function have been proposed when performing the incremental learning in the field of the artificial neural network which is a field of machine learning that has been actively studied recently, but most of them handle incremental learning for a change in a target variable, and do not handle the change in the variable space. Several learning algorithms, which may be used in varying feature spaces, such as generative learning with streaming capricious data (GLSC), have also been proposed, but all the several learning algorithms exist as individual algorithms, and have limitations in that they are not preprocessing techniques that may be widely applied regardless of a specific classification algorithm.

### SUMMARY OF THE INVENTION

The present invention is directed to providing a preprocessing device and method capable of being applied to incremental learning of a classifier with a varying feature space which is very important in machine learning applications in the fields of medicine, industry, and finance.

The present invention is directed to providing a preprocessing device and method in which information on a variable space is extracted and stored, and a problem specific to a varying feature space is reflected in learning of a classifier based on the information, unlike the existing preprocessing technique.

An aspect of the present invention is not limited to the above-described aspect. That is, other aspects that are not described may be obviously understood by those skilled in the art from the following specification.

A preprocessing device for learning data of a classifier includes: a variable spatial information extractor configured to receive data for learning of the classifier, calculate an appearance frequency of each variable combination based on the data, and calculates a cumulative appearance frequency of each variable combination by cumulating and summing the appearance frequency of each variable combination; and a data preprocessor configured to generate a prediction variable—target variable frequency matrix based on the appearance frequencies of each variable combination, apply Laplace smoothing to the frequency matrix according to the cumulative appearance frequency to calculate a probability value of each variable combination, and provide the probability value of each variable combination to the classifier.

The data preprocessor may select a variable combination as a learning target of the classifier based on the cumulative appearance frequency, and provide the probability value of each variable combination corresponding to the selected variable combination to the classifier.

The variable spatial information extractor may receive, as data for the learning of the classifier, data according to any one data type of instance and mini-batch.

The variable spatial information extractor may calculate the appearance frequency of each variable combination by binarizing the data.

The variable spatial information extractor may derive a probability distribution for the appearance frequency of each variable combination from the data, and the data preprocessor may generate the frequency matrix based on the probability distribution.

The data preprocessor may calculate a Laplace smoothing parameter based on the cumulative appearance frequency and a critical appearance frequency, and apply the Laplace smoothing to the frequency matrix according to the Laplace smoothing parameter to calculate the probability value of each variable combination.

The data preprocessor may calculate a selection probability of each variable combination based on the cumulative appearance frequency, and select a variable combination as a learning target of the classifier based on the selection probability of each variable combination and the target number of variable combinations to be dropped.

The data preprocessor may calculate a selection probability of each variable combination based on a reciprocal of the cumulative appearance frequency, and select a variable combination as a learning target of the classifier based on the selection probability of each variable combination and the target number of variable combinations to be dropped.

A preprocessing device for learning data of a classifier includes: a variable spatial information extractor configured to receive data for learning of the classifier, calculate an appearance frequency of each variable combination based on the data, and calculate a cumulative appearance frequency of each variable combination by cumulating and summing the appearance frequency of each variable combination; and a data preprocessor configured to generate a prediction variable—target variable frequency matrix based on the appearance frequency of each variable combination, calculate a probability value of each variable combination based on the frequency matrix, select a variable combination as a learning target of the classifier, based on the cumulative appearance frequency, and provide the probability value of each variable combination corresponding to the selected variable combination to the classifier.

The data preprocessor may calculate a selection probability of each variable combination based on the cumulative appearance frequency, and select a variable combination as the learning target of the classifier based on the selection probability of each variable combination and the target number of variable combinations to be dropped.

The data preprocessor may calculate a selection probability of each variable combination based on a reciprocal of the cumulative appearance frequency, and select a variable combination as the learning target of the classifier based on the selection probability of each variable combination and the target number of variable combinations to be dropped.

A preprocessing method of learning data of a classifier includes: an appearance frequency extraction operation of receiving data for learning of the classifier and calculating an appearance frequency of each variable combination; a cumulative appearance frequency update operation of calculating a cumulative appearance frequency of each variable combination by cumulating and summing the appearance frequencies of each variable combination; a confidence-based smoothing operation of generating a prediction variable—target variable frequency matrix based on the appearance frequencies of each variable combination, and applying Laplace smoothing to the frequency matrix according to the cumulative appearance frequency to calculate a probability value of each variable combination; and a classifier learning operation of providing the probability value of each variable combination to the classifier.

The processing method may further include: a dropout operation of selecting a variable combination as a learning target of the classifier based on the cumulative appearance frequency after the confidence-based smoothing operation, in which the learning of the classifier may provide a probability value of each variable combination corresponding to the variable combination to the classifier.

The preprocessing method may further include: a variable selection probability calculation operation of calculating a selection probability of each variable combination based on the cumulative appearance frequency after the confidence-based smoothing operation; and a dropout operation of selecting a variable combination as a learning target of classifier based on a selection probability of each variable combination and the target number of variable combinations to be dropped, in which the learning of the classifier may provide the probability value of each variable combination corresponding to the variable combination to the classifier.

In the appearance frequency extraction operation, a probability distribution for the appearance frequency of each variable combination may be derived from the data, and in the confidence-based smoothing operation, the frequency matrix may be generated based on the probability distribution.

In the confidence-based smoothing operation, a Laplace smoothing parameter may be calculated based on the cumulative appearance frequency and a critical appearance frequency, and the probability value of each variable combination may be calculated by applying Laplace smoothing to the frequency matrix according to the Laplace smoothing parameter.

In the variable selection probability calculation operation, the selection probability of each variable combination may be calculated based on a reciprocal of the cumulative appearance frequency.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a configuration of a preprocessing device for learning data of a classifier according to an embodiment of the present invention;

FIG. 2 is a diagram illustrating an example of binarization of original data and generation of an appearance frequency matrix of each variable combination;

FIG. 3 is a diagram illustrating an example of a confidence-based smoothing result;

FIG. 4 is an exemplary diagram of an adaptive dropout result; and

FIG. 5 is a flowchart for describing a pre-processing method of learning data of a classifier according to an embodiment of the present invention.

FIG. 6 is a block diagram illustrating a configuration of computer system to perform methods according to an embodiment of the present disclosure.

### DETAILED DESCRIPTION OF EXEMPLARY EMBODIMENTS

Various advantages and features of the present invention and methods accomplishing them will become apparent from the following description of embodiments with reference to the accompanying drawings. However, the present invention is not limited to exemplary embodiments to be described below, but may be implemented in various different forms, these embodiments will be provided only in order to make the present invention complete and allow those skilled in the art to completely recognize the scope of the present invention, and the present invention will be defined by the scope of the claims. Meanwhile, terms used in the present specification are for explaining exemplary embodiments rather than limiting the present invention. Unless otherwise stated, a singular form includes a plural form in the present specification. Components, steps, operations, and/or elements mentioned by the terms “comprise” and/or “comprising” used in the present invention do not exclude the existence or addition of one or more other components, steps, operations, and/or elements.

When it is decided that the detailed description of the known art related to the present invention may unnecessarily obscure the gist of the present invention, such detailed description will be omitted.

The present invention relates to a preprocessing device and method for improving stability and robustness of learning and prediction of a classifier in a varying feature space. The varying feature space is a situation in which a variable or feature space of data that the classifier intends to learn continuously changes. For example, a variable space in which a situation in which an existing variable is deleted or a new variable is added occurs corresponds to the varying feature space.

The preprocessing device and method according to the present invention may be additionally applied to input and output data of a classifier when incremental learning is performed on a varying feature space. The present invention reflects the variable space bias problem of the varying feature space in learning through \textcircled{1} confidence-based smoothing and \textcircled{2} an adaptive dropout technique based on information extraction for the varying feature space. The above two techniques are sequentially applied to input data, and the result is again given as an input to the classifier. Although the above two techniques may be used separately, the two techniques may work more stably and effectively when used together.

Hereinafter, embodiments of the present disclosure will be described in detail with reference to the accompanying drawings. The same means will be denoted by the same reference numerals throughout the accompanying drawings in order to facilitate the general understanding of the present invention in describing the present invention.

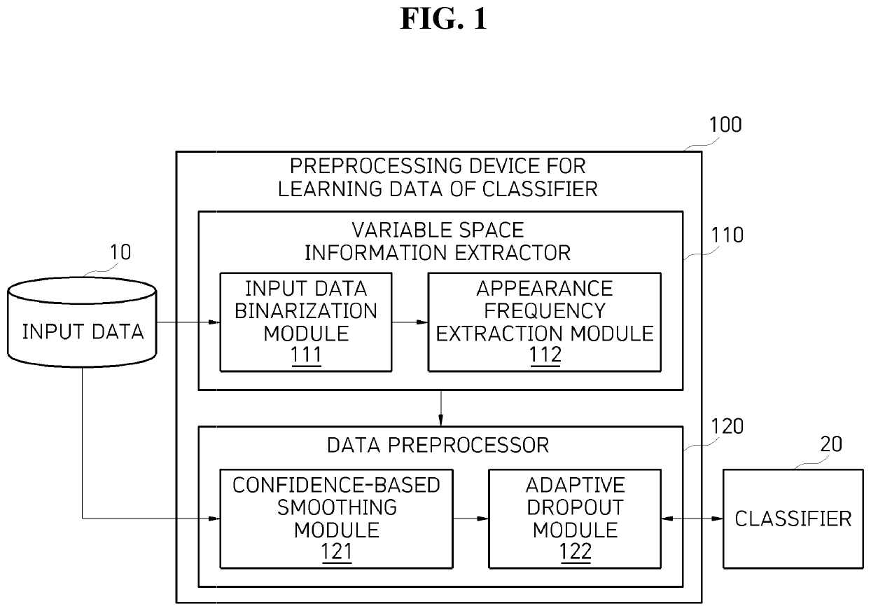

FIG. 1 is a block diagram illustrating a configuration of a preprocessing device for learning data of a classifier according to an embodiment of the present invention.

The preprocessing device 100 for learning data of a classifier according to the embodiment of the present invention includes a variable spatial information extractor 110 and a data preprocessor 120.

FIG. 1 schematically illustrates a process of preprocessing the input data 10 by a preprocessing device for learning data of a classifier to train the classifier 20.

The variable spatial information extractor 110 binarizes the input data 10 and generates appearance frequency information of each variable combination based on the binarized input data 10 and transmits the generated appearance frequency information to the data preprocessor 120, and the data preprocessor 120 changes an input data value itself based on the input data 10 and the appearance frequency information of each variable combination through a confidence-based smoothing module, and changes the form of the input data value through an adaptive dropout module 122. The “change in input data type” performed by the adaptive dropout module 122 includes an operation of selecting a variable by applying a variable selection probability and a variable drop rate DR.

The data preprocessor 120 again generates learning data required for iterative learning of the classifier 20 using the adaptive dropout technique every time and provides the generated learning data to the classifier 20, so that the difference in the amount of information between the data learned by the classifier 20 and the original input data 10 is minimized.

Although the present invention is not limited to a specific classification algorithm and can be applied to various classification algorithms, a Naïve Bayes classification algorithm is briefly introduced below as an example, and a process of applying the preprocessing technique (variable stabilization technique) provided by the present invention based on the Naïve Bayes classification algorithm will be described.

The Naïve Bayes algorithm finds a value y of a target variable Y satisfying maximum likelihood estimation (MLE) for data x=(x₁, . . . , xₙ) existing in a variable space composed of n variables X₁, . . . , Xₙ at a current time point (t). That is, y satisfying the following [Equation 1] is found.

$${arg max}_{y ∈ Val ( Y )} ( P ( y \vert {x}_{1} , … {x}_{n} ) ) = {arg max}_{y ∈ Val ( Y )} ( \frac{P ( y ) P ( {x}_{1} , … {x}_{n} \vert y )}{P ( {x}_{1} , … {x}_{n} )} ) \qquad [ Equation 1 ]$$

In [Equation 1], Val(Y) denotes a set including all possible values of the variable Y, which is also the same for other equations.

In this case, a decomposition of a joint probability distribution (also called a combination probability distribution) is facilitated by assuming probabilistic independence between variables. That is, the final equation used for prediction is as in [Equation 2]. A log function is applied to each probability value for convenience in calculation.

$${arg max}_{y ∈ Val ( Y )} ( P ( y \vert {x}_{1} , … {x}_{n} ) ) = {arg max}_{y ∈ Val ( Y )} ( log P ( y ) + {\sum }_{i = 1}^{n} log P ( {x}_{i} \vert y ) ) \qquad [ Equation 2 ]$$

By applying a weight parameter wᵢ that can be optimized for each variable [Equation 2], the form shown in [Equation 3] may be obtained. Gradient descent may be applied to artificial neural networks by adding weight parameters, and may be extended to various algorithms using a kernel or ensemble technique.

$${arg max}_{y ∈ Val ( Y )} ( P ( y \vert {x}_{1} , … {x}_{n} ) ) = {arg max}_{y ∈ Val ( Y )} ( log P ( y ) + {\sum }_{i = 1}^{n} {w}_{i} log P ( {x}_{i} \vert y ) ) \qquad [ Equation 3 ]$$

In the following, in the process of optimizing wᵢ introduced in [Equation 3], a method of providing learning data to the classifier 20 by allowing the preprocessing device 100 for learning data of a classifier to apply \textcircled{1} confidence-based smoothing technique and \textcircled{2} adaptive dropout technique to the input data 10 will be described in detail.

In order for the data preprocessor 120 of the preprocessing device 100 for learning data of a classifier to apply the confidence-based smoothing technique and the adaptive dropout technique to the input data 10, variable space information, that is, appearance frequency information of each variable combination is required. The variable spatial information extractor 110 binarizes the input data 10, extracts the appearance frequency information of each variable combination, and transmits the extracted appearance frequency information to the data preprocessor 120.

The variable spatial information extractor 110 includes an input data binarization module 111 and an appearance frequency extraction module 112.

The data preprocessor 120 includes a confidence-based smoothing module 121 for application of the confidence-based smoothing technique and an adaptive dropout module 122 for application of the adaptive dropout technique.

Input Data Binarization Module 111

When performing incremental learning in a varying feature space, learning data is classified according to a variable space and input to the classifier 20. Accordingly, the input data set 10 may include individual instances or mini-batches from the same variable space.

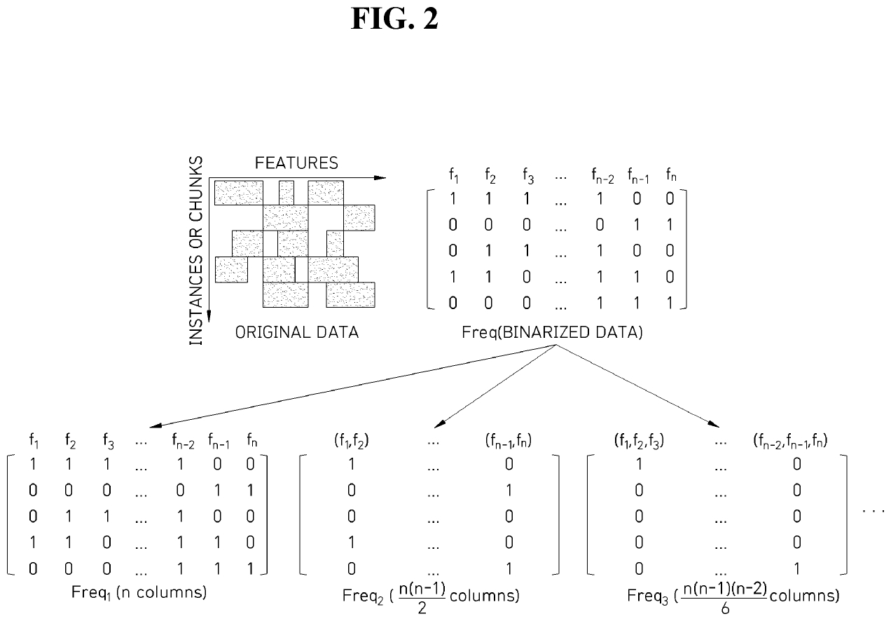

When data for such a variable space is learned, the appearance frequency of each variable may be irregular and unequal according to its variable nature, so the data to be input to the classifier 20 should be individually stored to utilize the relevant information. As a method of storing variable space information, various methods from a method of storing all input data to a method of simply storing the number of instances are possible. In an embodiment of the present invention, the input data binarization module 111 of the variable spatial information extractor 110 binarizes a value while maintaining the variable information on the input data and stores the binarized value as a matrix Freq (see FIG. 2).

Appearance Frequency Extraction Module 112

A process in which the appearance frequency extraction module 112 extracts appearance information of each variable combination will be described below. The appearance frequency extraction module 112 extracts Freq_{depth} which is a matrix (hereinafter, “appearance frequency matrix of each variable combination”) representing appearance information of each variable combination according to a size (hereinafter, “depth”) of a maximum variable combination to be extracted. FIG. 2 illustrates the change in the appearance frequency matrix Freq_{depth} of each variable combination according to the depth of the maximum variable combination. As can be seen from FIG. 2, when the depth is set to be large, the size of the variable combination to be handled may increase, and more accurate data information may be stored. This method has the advantage of being able to more flexibly set the precision of information storage according to a given computing resource. However, since the size of the matrix Freq_{depth} increases exponentially with the depth, when the number of variables is large and the depth is large, Freq_{depth} approximates a specific distribution and is used. In the present specification, for convenience, the description is limited to the case where the depth is 1.

Then, the appearance frequency extraction module 112 proceeds to sum the Freq_{depth} by row-by-row to obtain Freq_{depth,sum} which is a vector (hereinafter, “appearance frequency vector of each variable combination”) indicating the number of appearances of each variable combination. The appearance frequency extraction module 112 transmits the appearance frequency vector Freq_{depth,sum} of each variable combination to the data preprocessor 120.

Then, the appearance frequency extraction module 112 cumulates and sums the appearance frequency vectors of each variable combination from a first input data set to a latest (t^{th}) input data set. When the depth is 1, the appearance frequency extraction module 112 stores the appearance frequency as an appearance frequency vector Freq_{1,sum}=(c₁, . . . , cₙ) of each variable combination composed of n integer values for n variables. In this case, note that the appearance frequency is calculated based on the number of individual instances, not the number of input data sets. Therefore, a cumulative appearance frequency of a variable Xᵢ appearing in the t^{th} input data set composed of m instances is updated as cᵢ′=cᵢ+m. That is, the appearance frequency extraction module 112 adds the appearance frequency vector of each variable combination generated based on the t^{th} input data set to the previously (first to the (t−1)^{th}) accumulated and aggregated appearance frequency vector (hereinafter “cumulative appearance frequency vector of each variable combination”) of each variable combination to update the cumulative appearance frequency vector of each variable combination, and transmits the updated cumulative appearance frequency vector of each combination to the data preprocessor 120.

Confidence-Based Smoothing Module 121

A process in which the confidence-based smoothing module 121 applies the Laplace smoothing technique to the input data 10 based on the confidence of each variable combination will be described.

Input data log P(xᵢ|y) corresponding to the weight parameter wᵢ contains correlation information between the variable Xᵢ and the target variable Y. The confidence about how closely the corresponding information approximates a population distribution varies for each variable, and this confidence is generally proportional to the number of data instances containing the variables Xᵢ and Y learned by the classifier. For example, even if P(Xₕ,Y) and P(Xₖ,Y) have the same distribution, when the variable Xₕ is learned 10000 times and the variable Xₖ is learned 100 times, these two variables may be reflected in learning with the same confidence, which may cause a problem that Xₖ, which is a variable with relatively low confidence, is handled equally to Xₕ. Therefore, it is necessary to properly utilize information on confidence, which is important for prediction in a situation with strong uncertainty, in the preprocessing process of classifier learning data.

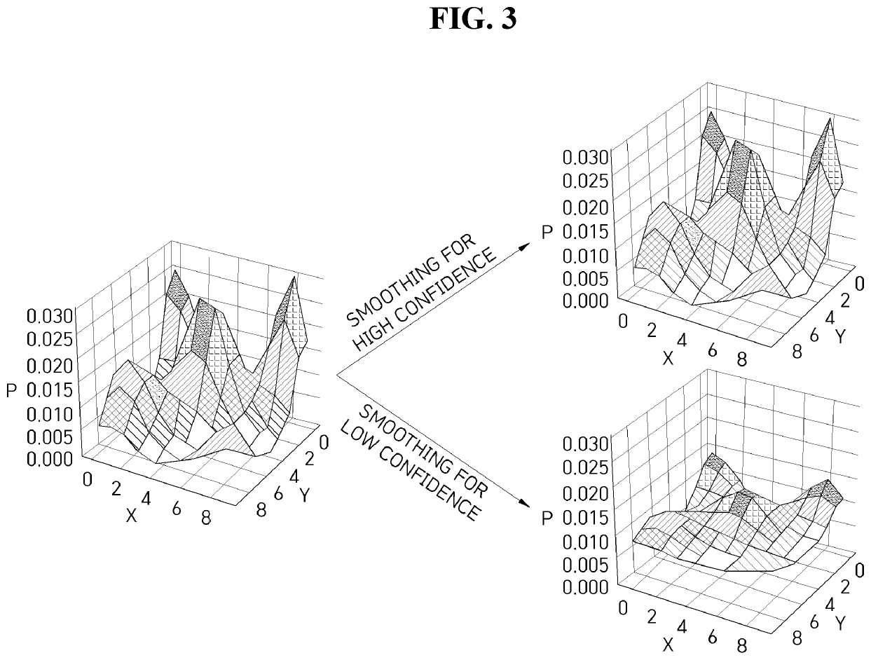

The confidence-based smoothing module 121 uses the confidence information for the Laplace smoothing through the confidence-based smoothing technique to be directly reflected in the probability distribution. For variables with high confidence, P(xᵢ|y) is maximally reflected in the prediction by minimizing the Laplace smoothing, and for variables with low confidence, P(xᵢ|y) is made close to uniform distribution through Laplace smoothing to be conservatively reflected in prediction (see FIG. 3).

The confidence-based smoothing module 121 reflects the confidence (confidence of each variable when depth=1) of each variable combination in the Laplace smoothing. The confidence-based smoothing module 121 may reflect the confidence in the Laplace smoothing by reflecting the confidence of each variable combination in the Laplace smoothing parameter calculation. The confidence of each variable combination may be (1) quantified by a cumulative learning input frequency of each variable combination, or may be indirectly quantified by (2) a cumulative appearance frequency of each variable combination when it is difficult to collect the cumulative learning input frequency of each variable combination.

(1) The method for confidence-based smoothing module 121 to calculate a Laplace smoothing parameter α using a cumulative learning input frequency of each variable combination is as follows. For convenience, the depth is assumed to be 1 (that is, in this case, the cumulative learning input frequency of each variable combination becomes the cumulative learning input frequency of each variable). When the data received by the preprocessing device 100 is the t^{th} input data, the confidence-based smoothing module 121 uses the number of times (“cumulative learning input frequency of each variable combination”) dᵢ input to the learning of the classifier from the first input data to the (t−1)^{th} input data for a specific variable Xᵢ in the calculation of the Laplace smoothing α. The cumulative learning input frequency dᵢ of each variable combination (of each variable when depth=1) may be calculated by allowing the data preprocessor 120 itself to cumulatively aggregate the learning input frequency of each variable combination, or by cumulatively aggregating the learning input frequency of each variable combination fed back to the data preprocessor 120 after the learning by the classifier 20. Given the cumulative learning input frequency dᵢ for a specific variable Xᵢ, the Laplace smoothing parameter α is defined as

$$α = \frac{T h r e s D}{{d}_{i}} .$$

Here, ThresD (critical learning frequency) is the size of the cumulative learning input frequency dᵢ required to trust the specific variable Xᵢ. When the cumulative learning input frequency dᵢ is greater than or equal to the critical learning frequency (dᵢ≥ThresD), the Laplace smoothing parameter α may be set to 1, which is to avoid numerical errors that may occur during calculation through application of minimal Laplace smoothing.

(2) The method for a confidence-based smoothing module 121 to calculate a Laplace smoothing parameter α using a cumulative appearance frequency of each variable combination is as follows. Similar to (1), the depth is assumed to be 1 (that is, in this case, the cumulative appearance frequency of each variable combination becomes the cumulative appearance frequency of each variable). When the data received by the preprocessing device 100 is the t^{th} input data, the confidence-based smoothing module 121 uses the number of appearances (“cumulative learning input frequency of each variable combination”) cᵢ in the learning of the classifier from the first input data to the t^{th} input data for a specific variable Xᵢ in the calculation of the Laplace smoothing α. As described above, cᵢ is the sum of the number of instances in which the data of the specific variable appears from the first input data to the t^{th} input data. The cumulative appearance frequency cᵢ of each variable combination (of each variable when depth=1) may be extracted from the cumulative appearance frequency vector of each variable combination updated up to the t^{th} input data. That is, when the cumulative appearance frequency vector of each variable combination updated for the t^{th} input data in the variable spatial information extractor 110 is transmitted to the data preprocessor 120, the confidence-based smoothing module 121 may extract the cumulative appearance frequency of the specific variable combination from the cumulative appearance frequency vector of each variable combination. Given the cumulative learning input frequency cᵢ for the specific variable Xᵢ, the Laplace smoothing parameter α is defined as

$$α = \frac{ThresC}{{c}_{i}} .$$

Here, ThresC (critical appearance frequency) is the size of the cumulative appearance frequency cᵢ required to trust the specific variable Xᵢ. When the cumulative appearance frequency is greater than or equal to the critical appearance frequency (cᵢ≥ThresC), the Laplace smoothing parameter α may be set to 1, which is to avoid the numerical errors that may occur during the calculation through the application of the minimal Laplace smoothing.

Through either method (1) or (2) described above, the confidence of each variable combination may be quantified, and the Laplace smoothing parameter α may be calculated.

When the Laplace smoothing parameter α is calculated, the confidence-based smoothing module 121 calculates P(Xᵢ,Y) using \hat{F}(Xᵢ, Y) after calculating \hat{F}(Xᵢ, Y) as in Equation 4.

$$\hat{F} ( {X}_{i} , Y ) = F ( {X}_{i} , Y ) + α = [ \begin{matrix}{F}_{1 , 1} + α & … & {F}_{1 , \vert Y \vert} + α \\ ⋮ & ⋱ & ⋮ \\ {F}_{\vert {X}_{i} \vert , 1} + α & … & {F}_{\vert {X}_{i} \vert , \vert Y \vert} + α\end{matrix} ] \qquad [ Equation 4 ]$$

In [Equation 4], |Xi| and | mean the numbers of all cases (size of a set or the number of members of a set) of values that Xi and Y may have. Also, in [Equation 4], F(Xᵢ,Y) is a matrix (“prediction variable—target variable frequency matrix”) to which target variable Y information is added based on Freq_{depth}. For example, when Freq_{depth} is

$$[ \begin{matrix}1 & 0 \\ 0 & 1 \\ 1 & 1\end{matrix} ] ,$$

and the target variable Y corresponding to each row of Freq_{depth} is represented by

$$[ \begin{matrix}\begin{matrix}1 \\ 2\end{matrix} \\ 1\end{matrix} ]$$

(e.g., Y=1 when X₁=1, X₂=0; assume that Val(Y)={1,2}), since the case where X₁ is 0 and Y is 2 is once, and the case where X₁ is 1 and Y is 1 is twice, F(X₁,Y) becomes

$$[ \begin{matrix}0 & 1 \\ 2 & 0\end{matrix} ] .$$

Here, F_{1,1}=0, F_{1,2}=1, F_{2,1}=2, and F_{2,2}=0. By adding the Laplace smoothing parameter α to each component of F(X₁,Y), \hat{F}(X₁, Y) may be obtained. For data to be applied to the Naïve Bayes classifier, the smoothing is possible with Freq_{1,sum} as in [Equation 4], but even Freq_{2,sum} or Freq_{3,sum} may be needed in the Bayes classifier that handles complex correlations.

Adaptive Dropout Module 122

For adaptive dropout, a process of extracting and storing information (e.g., appearance frequency of each variable combination) on input data is required. The adaptive dropout module 122 may use Freq_{1,sum}, Freq_{2,sum}, . . . , Freq_{depth,sum} which are the appearance frequency vectors of each variable combination generated by the variable spatial information extractor 110. When the adaptive dropout module 122 drops out the t^{th} input data, the adaptive dropout module 122 may perform the dropout using (1) the appearance frequency vector of each variable combination for the t^{th} input data, or (2) perform adaptive dropout using the cumulative appearance frequency vector of each variable combination that aggregates the appearance frequencies from the first input data to the t-th input data of each variable combination.

First, the adaptive dropout module 122 calculates a selection probability of each variable combination. An example of calculating the selection probability of each variable combination by using the appearance frequency vector of each variable combination as in (1) will be described.

When handling the varying feature space, there is a need to consider the differences between the two variable spaces in addition to the learning data and the test data value themselves. The parameters of the classifier converge to parameters biased in the learning data through the learning. When this bias is not valid for the test data (i.e., overfitting), the performance of the actual classifier is lowered. Therefore, when the learning is performed in the varying feature space, it is necessary to exclude the variable space bias caused by continuously learning a specific variable combination as much as possible.

To this end, in the present invention, an adaptive dropout that makes a distribution of the probability of selecting a variable combination (variable) close to a uniform distribution is performed on the variable space based on Freq_{1,sum}, Freq_{2,sum}, . . . , Freq_{depth,sum} which are the information (appearance frequency vectors of each variable combination) on the appearance frequency of various variable combinations. The probability of selecting the specific variable combination (or specific variable) is set as in [Equation 5] based on the appearance frequency of each variable combination.

$${P}_{select} ( {X}_{i} ) = \frac{{\sum }_{j} … {\sum }_{k} \frac{1}{{c}_{i , j , … , k}}}{{\sum }_{i} {\sum }_{j} … {\sum }_{k} \frac{1}{{c}_{i , j , … , k}}} \qquad [ Equation 5 ]$$

In [Equation 5], k is a specific element (appearance frequency of each variable combination) of Freq_{depth,sum}, and i,j, . . . , k are indexes of 1, 2, . . . , depth variable. When a variable to participate in learning is selected according to [Equation 5], the less the variable of the appearance frequency of the combination, the greater the probability that the corresponding variable will be selected for learning through [Equation 5]. In addition, through the application of [Equation 5], the probability distribution in which variables are selected for the learning of the classifier gradually approximates the uniform distribution as various instances are learned.

As another example of the present invention, the adaptive dropout module 122 may calculate the selection probability of each variable combination based on the cumulative appearance frequency of each variable combination. In this case, in [Equation 5], c_{i,j}, . . . , k is the cumulative appearance frequency of each variable combination.

The adaptive dropout module 122 calculates the selection probability of each variable combination according to [Equation 5] and then performs the dropout. The adaptive dropout module 122 needs to set a drop rate DR in addition to a variable combination selection probability (P_{select}(Xᵢ)) in order to perform dropout on the t^{th} input data. The drop rate DR is a ratio of how many variable combinations (or variables) will be dropped. The drop rate is introduced to induce the stable learning of the classifier 20 by maintaining the number of variable combinations (or variables) input to the classifier 20 at a similar level in the incremental learning process. For example, when the depth is 1, the drop rate is set according to the number of variables dt of the t^{th} input data as in [Equation 6]. In [Equation 6], d_{target} is a target value of the number of variables input to the classifier in the entire learning process for the classifier.

$$D R = 1 - \frac{{d}_{target}}{{d}_{t}} \qquad [ Equation 6 ]$$

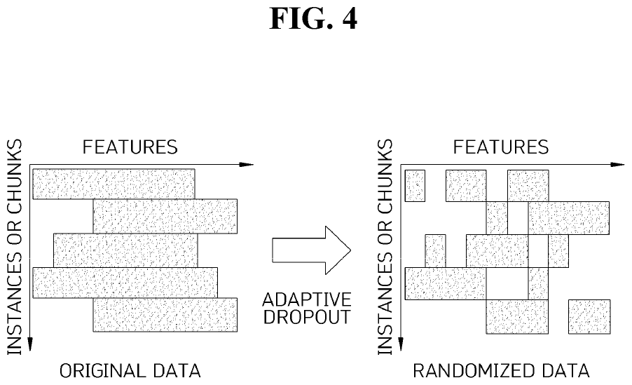

Through the adaptive dropout, the changed learning data may be transmitted to the classifier so that the shape of the input data, that is, the variable combination applied to the learning of the classifier, is not biased with respect to the specific variable space (see FIG. 4).

The t^{th} input data goes through the preprocessing process for learning, and the learning data, that is, the probability value of each variable combination (when the depth is 1, the probability value of each variable) is transmitted from the data preprocessor 120 to the classifier 20. In this case, the dropout may be applied to the probability value of each variable combination. That is, the probability value of the selected variable combination may be transmitted to the classifier 20. The probability value of each variable combination transmitted to the classifier is generally the conditional probability (e.g., P(Xᵢ|Y), etc.) of the specific variable Xᵢ for the target variable, but may be the probability that Xᵢ and Y occur (e.g., P(Xᵢ,Y), etc.) depending on the purpose.

The classifier 20 may calculate an error by applying the learning data, and obtain a change amount of a model parameter based on the t^{th} input data, that is, a change amount of a classifier parameter, by using the gradient descent method. Thereafter, the classifier 20 repeatedly updates the model parameters a certain number of times in the same way as in the existing machine learning. When the update is terminated, the learning for the t^{th} input data is terminated.

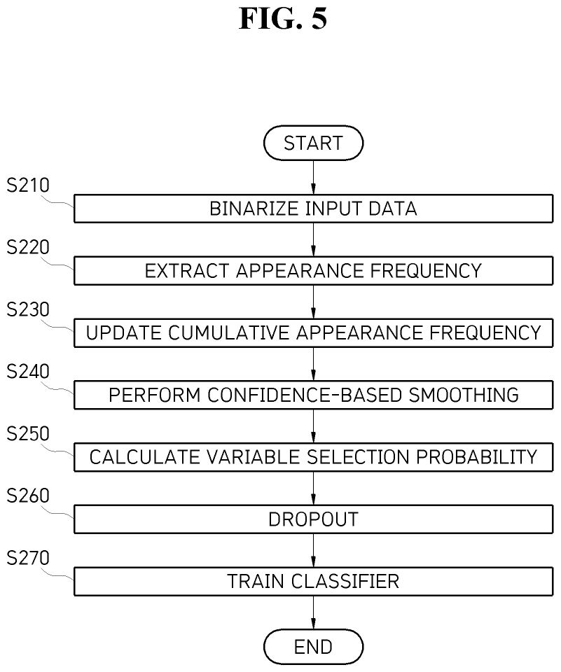

FIG. 5 is a flowchart for describing a preprocessing method of learning data of a classifier according to an embodiment of the present invention.

The preprocessing method of learning data of a classifier according to the embodiment of the present invention includes operations S210 to S270. When operations S210 to S270 are performed, classifier learning for specific input data is completed. When operations S210 to S270 are performed, the learning of the classifier for the specific input data is completed.

Operation S210 is an input data binarization operation. The variable spatial information extractor 110 generates a binarization matrix by binarizing a data set (“input data set”) received for the learning of the classifier. In this case, the input data set may be in the form of an instance or in the form of a mini-batch.

Operation S220 is an appearance frequency extraction operation. The variable spatial information extractor 110 generates a matrix (“appearance frequency matrix of each variable combination”) indicating the appearance information of each variable combination in the binarization matrix according to the size (“depth”) of the maximum variable combination to be extracted. In addition, the variable spatial information extractor 110 generates the appearance frequency vector of each variable combination by adding the appearance frequency of each variable combination to the corresponding input data set range using the appearance frequency matrix of each variable combination. That is, the appearance frequency vector of each variable combination is a vector in which the appearance frequency (the number of instances of each variable combination) of each variable combination with respect to the input data set is indicated. The variable spatial information extractor 110 transmits the appearance frequency vector of each variable combination to the data preprocessor 120. The details have been described above in the description of the appearance frequency extraction module 112.

Operation S230 is a cumulative appearance frequency update operation. The variable spatial information extractor 110 updates the cumulative appearance frequency vector of each variable combination by adding the cumulative appearance frequency vector (in the case of the second input data set, the appearance frequency vector of each variable combination generated for the first input data set) of each variable combination that is previously cumulatively aggregated to the appearance frequency vector of each variable combination generated based on the input data set. As described above, the value added to each component of the cumulative appearance frequency vector of each variable combination is the number of instances of each variable combination on the latest (e.g., t^{th}) input data set. The variable spatial information extractor 110 transmits the updated cumulative appearance frequency vector of each variable combination to the data preprocessor 120. The details have been described above in the description of the appearance frequency extraction module 112.

Operation S240 is a confidence-based smoothing operation. The data preprocessor 120 performs the Laplace smoothing based on the confidence of each variable combination. The data preprocessor 120 may reflect the confidence in the Laplace smoothing by reflecting the confidence of each variable combination in the Laplace smoothing parameter calculation. The confidence of each variable combination may be (1) quantified by a cumulative learning input frequency of each variable combination, or may be indirectly quantified by (2) a cumulative appearance frequency of each variable combination when it is difficult to collect the cumulative learning input frequency of each variable combination. The data preprocessor 120 may calculate the Laplace smoothing parameter using (1) the cumulative learning input frequency of each variable combination or (2) the cumulative appearance frequency of each variable combination. The data preprocessor 120 performs the smoothing by applying the Laplace smoothing parameter α to a “prediction variable—target variable frequency matrix F,” and calculates the probability of each variable combination based on the smoothed prediction variable—target variable frequency matrix (\hat{F}) (e.g., when depth=1, calculate P(Xᵢ,Y) of each Xᵢ). The details have been described above through the description of the confidence-based smoothing module 121.

Operation S250 is a variable selection probability calculation operation. The data preprocessor 120 calculates a probability (probability distribution) of each variable combination being selected for the learning of the classifier. This operation is a preparation operation for executing adaptive dropout. The data preprocessor 120 may calculate the probability (“selection probability of each variable combination”) of each variable combination being selected based on the appearance frequency of each variable combination or the cumulative appearance frequency of each variable combination. The details have been described above through the description of the adaptive dropout module 122.

Operation S260 is a dropout operation. The data preprocessor 120 selects the variable combination input to the learning of the classifier 20 based on the selection probability (or probability distribution) of each variable combination and the drop rate DR. The drop rate DR is a rate of how many variable combinations (or variables) will be dropped. The drop rate is introduced to induce the stable learning of the classifier by maintaining the number of variables input to the classifier 20 at a similar level in the incremental learning process. When the depth is 1, the drop rate may be set according to the number of variables dt of the t^{th} input data set as in [Equation 6] described above. When the dropout is completed, the variable combination to be input to the learning of the classifier 20 is confirmed. The details have been described above through the description of the adaptive dropout module 122.

Operation S270 is a training classifier operation. The data preprocessor 120 constructs learning data with an instance for the variable combination to be input to the learning or the probability (e.g., P(Xᵢ,Y)) of each variable combination, and provides the constructed learning data to the classifier 20. The classifier 20 may calculate an error by applying the learning data, and obtain the change amount of the model parameter based on the t^{th} input data, that is, the change amount of the classifier parameter, by using the gradient descent method. Thereafter, the classifier 20 repeatedly updates the model parameters a certain number of times in the same way as in the existing machine learning. When the update is completed, the learning for the t^{th} input data is completed.

In operation S270, the data preprocessor 120 accumulates the learning input frequency of each variable combination. That is, the data preprocessor 120 aggregates the number of times applied to classifier learning of each variable combination (or of each variable). The data preprocessor 120 may reflect the learning input frequency (the number of times learned) of each variable combination in the Laplace smoothing process of operation S240. As another example, the learning input frequency (the number of times learned) of each variable combination may be fed back to (receive by) the data preprocessor 120 from the classifier 20 and it may use the learning input frequency for the confidence-based smoothing.

Meanwhile, in the description with reference to FIG. 5, each operation may be further divided into additional operations or combined into fewer operations according to an implementation example of the present invention. Also, some operations may be omitted if necessary, and an order between the operations may be changed. In addition, the content of FIGS. 1 to 4 may be applied to the content of FIG. 5 even when other content is omitted. Also, the content of FIG. 5 may be applied to the content of FIGS. 1 to 4.

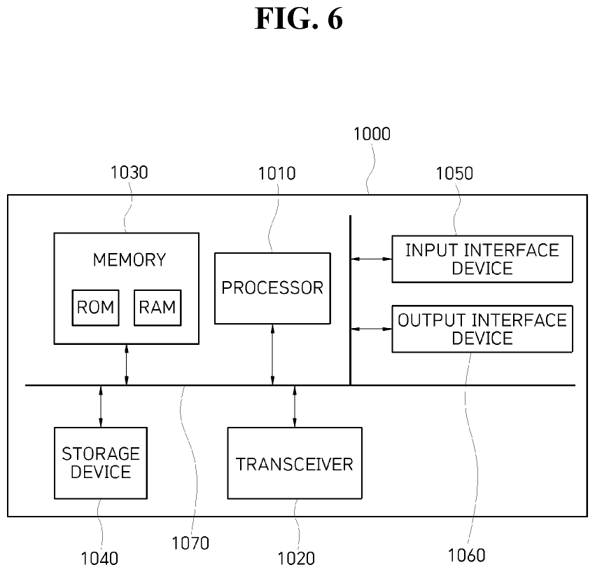

FIG. 6 is a block diagram illustrating a configuration of computer system to perform methods according to an embodiment of the present disclosure.

The computer system 1000 may include at least one processor 1010, a memory 1030 for storing at least one instruction to be executed by the processor 1010, and a transceiver 1020 performing communications through a network. The transceiver 1020 may transmit or receive a wired signal or a wireless signal.

The computer system 1000 may further include a storage device 1040, an input interface device 1050 and an output interface device 1060. The components of the computer system 1000 may be connected through a bus 1070 to communicate with each other.

The processor 1010 may execute program instructions stored in the memory 1030 and/or the storage device 1040. The processor 1010 may include a central processing unit (CPU) or a graphics processing unit (GPU), or may be implemented by another kind of dedicated processor suitable for performing the methods of the present disclosure.

The memory 1030 may load the program instructions stored in the storage device 1040 to provide to the processor 1010. The memory 1030 may include, for example, a volatile memory such as a read only memory (ROM) and a nonvolatile memory such as a random access memory (RAM).

The storage device 1040 may store the program instructions that can be loaded to the memory 1030 and executed by the processor 1010. The storage device 1040 may include an intangible recording medium suitable for storing the program instructions, data files, data structures, and a combination thereof. Examples of the storage medium may include magnetic media such as a hard disk, a floppy disk, and a magnetic tape, optical media such as a compact disk read only memory (CD-ROM) and a digital video disk (DVD), magneto-optical medium such as a floptical disk, and semiconductor memories such as ROM, RAM, a flash memory, and a solid-state drive (SSD).

For reference, the components according to the embodiment of the present invention may be implemented in the form of software or hardware such as a digital signal processor (DSP), a field programmable gate array (FPGA), or an application specific integrated circuit (ASIC), and perform predetermined roles.

However, “components” are not limited to software or hardware, and each component may be in an addressable storage medium or configured to reproduce one or more processors.

Accordingly, for example, the components include components such as software components, object-oriented software components, class components, and task components, processors, functions, attributes, procedures, subroutines, segments of a program code, drivers, firmware, a microcode, a circuit, data, a database, data structures, tables, arrays, and variables.

Components and functions provided within the components may be combined into a smaller number of components or further divided into additional components.

Meanwhile, it will be appreciated that each block of a processing flowchart and combinations of the flowcharts may be executed by computer program instructions. Since these computer program instructions may be mounted in a processor of a general computer, a special computer, or another programmable data processing apparatus, these computer program instructions executed through the process of the computer or another programmable data processing apparatus create means performing functions described in a block(s) of the flowchart. Since the computer program instructions may also be mounted on the computer or another programmable data processing apparatus, the instructions to perform a series of operations on the computer or the other programmable data processing apparatus to create processes executed by the computer may also provide operations for performing the functions described in a block(s) of the flowchart.

In addition, each block may indicate some of modules, segments, or codes including one or more executable instructions for executing a specific logical function (specific logical functions). Further, it is to be noted that functions mentioned in the blocks occur regardless of a sequence in some alternative embodiments. For example, two blocks that are continuously illustrated may be simultaneously performed in fact or be performed in a reverse sequence depending on corresponding functions.

The term “-or/-er” or “module” used in the specification refers to a software component or a hardware component such as FPGA or ASIC, and the “-or/-er” or “module” performs certain roles. However, the “-or/-er” or “module” is not meant to be limited to software or hardware. The “-or/-er” or “module” may be stored in a storage medium that can be addressed or may be configured to regenerate one or more processors. Accordingly, as an example, “-or/-er_ or “module” refers to components such as software components, object-oriented software components, class components, and task components, processes, functions, attributes, procedures, subroutines, segments of program code, drivers, firmware, microcode, circuits, data, databases, data structures, tables, arrays and variables. Functions provided in components and the “-or/-er” or “modules” may be combined into fewer components and “-or/-er” or “modules,” or further separated into additional components and “-or/-er” or “modules.” In addition, components and “-or/-er” or “modules” may be implemented to play one or more CPUs in a device or a secure multimedia card.

The preprocessing method of learning data of a classifier has been described above with reference to the flowchart presented in the drawings. For simplicity, the method has been illustrated and described as a series of blocks, but the invention is not limited to the order of the blocks, and some blocks may occur with other blocks in a different order or at the same time as illustrated and described in the present specification. Also, various other branches, flow paths, and orders of blocks that achieve the same or similar result may be implemented. In addition, all the illustrated blocks may not be required for implementation of the methods described in the present specification.

According to the present invention, it is possible to improve a bias problem of a variable space that occurs in incremental learning in a varying feature space.

The preprocessing method according to the present invention is applied to the input data of the classifier and therefore is distinguished from the classifier algorithm itself. That is, the preprocessing method according to the present invention is an auxiliary learning technique that is additionally used for the classifier, unlike the existing incremental learning algorithm. Therefore, the present invention can be widely applied to various kinds of classifiers and can improve the stability and robustness of the learning of the classifier.

Effects which can be achieved by the present invention are not limited to the above-described effects. That is, other objects that are not described may be obviously understood by those skilled in the art to which the present invention pertains from the above detailed description.

Although the configuration of the present invention has been described in detail above with reference to the accompanying drawings, this is merely an example, and those skilled in the art to which the present invention pertains can make various modifications and changes within the scope of the technical spirit of the present invention. Accordingly, it is to be understood that the scope of the present invention will be defined by the claims rather than the above description and all modifications and alternations derived from the claims and their equivalents are included in the scope of the present invention.

What is claimed is:

1. A preprocessing device for learning data of a classifier, comprising:
a variable spatial information extractor configured to receive data for learning of the classifier, calculate an appearance frequency of each variable combination based on the data, and calculate a cumulative appearance frequency of each variable combination by cumulating and summing the appearance frequency of each variable combination; and
a data preprocessor configured to generate a prediction variable—target variable frequency matrix based on the appearance frequencies of each variable combination, apply Laplace smoothing to the frequency matrix according to the cumulative appearance frequency to calculate a probability value of each variable combination, and provide the probability value of each variable combination to the classifier.

2. The preprocessing device of claim 1, wherein the data preprocessor selects a variable combination as a learning target of the classifier based on the cumulative appearance frequency, and provides the probability value of each variable combination corresponding to the selected variable combination to the classifier.

3. The preprocessing device of claim 1, wherein the variable spatial information extractor receives, as data for the learning of the classifier, data according to any one data type of instance and mini-batch.

4. The preprocessing device of claim 1, wherein the variable spatial information extractor calculates the appearance frequency of each variable combination by binarizing the data.

5. The preprocessing device of claim 1, wherein the variable spatial information extractor derives a probability distribution for the appearance frequency of each variable combination from the data, and
the data preprocessor generates the frequency matrix based on the probability distribution.

6. The preprocessing device of claim 1, wherein the data preprocessor calculates a Laplace smoothing parameter based on the cumulative appearance frequency and a critical appearance frequency, and applies the Laplace smoothing to the frequency matrix according to the Laplace smoothing parameter to calculate the probability value of each variable combination

7. The preprocessing device of claim 2, wherein the data preprocessor calculates a selection probability of each variable combination based on the cumulative appearance frequency, and selects a variable combination as a learning target of the classifier based on the selection probability of each variable combination and the target number of variable combinations to be dropped.

8. The preprocessing device of claim 2, wherein the data preprocessor calculates a selection probability of each variable combination based on a reciprocal of the cumulative appearance frequency, and selects a variable combination as a learning target of the classifier based on the selection probability of each variable combination and the target number of variable combinations to be dropped.

9. A preprocessing device for learning data of a classifier, comprising:
a variable spatial information extractor configured to receive data for learning of the classifier, calculate an appearance frequency of each variable combination based on the data, and calculate a cumulative appearance frequency of each variable combination by cumulating and summing the appearance frequency of each variable combination; and
a data preprocessor configured to generate a prediction variable—target variable frequency matrix based on the appearance frequency of each variable combination, calculate a probability value of each variable combination based on the frequency matrix, select a variable combination as a learning target of the classifier, based on the cumulative appearance frequency, and provide the probability value of each variable combination corresponding to the selected variable combination to the classifier.

10. The processing device of claim 9, wherein the data preprocessor calculates a selection probability of each variable combination based on the cumulative appearance frequency, and selects a variable combination as the learning target of the classifier based on the selection probability of each variable combination and the target number of variable combinations to be dropped.

11. The preprocessing device of claim 9, wherein the data preprocessor calculates a selection probability of each variable combination based on a reciprocal of the cumulative appearance frequency, and selects a variable combination as the learning target of the classifier based on the selection probability of each variable combination and the target number of variable combinations to be dropped.

12. A preprocessing method of learning data of a classifier, comprising:
an appearance frequency extraction operation of receiving data for learning of the classifier and calculating an appearance frequency of each variable combination;
a cumulative appearance frequency update operation of calculating a cumulative appearance frequency of each variable combination by cumulating and summing the appearance frequencies of each variable combination;
a confidence-based smoothing operation of generating a prediction variable— target variable frequency matrix based on the appearance frequencies of each variable combination, and applying Laplace smoothing to the frequency matrix according to the cumulative appearance frequency to calculate a probability value of each variable combination; and
a classifier learning operation of providing the probability value of each variable combination to the classifier.

13. The processing method of claim 12, further comprising a dropout operation of selecting a variable combination as a learning target of the classifier based on the cumulative appearance frequency after the confidence-based smoothing operation,
wherein the learning of the classifier provides a probability value of each variable combination corresponding to the variable combination to the classifier.

14. The processing method of claim 12, further comprising:
a variable selection probability calculation operation of calculating a selection probability of each variable combination based on the cumulative appearance frequency after the confidence-based smoothing operation; and
a dropout operation of selecting a variable combination as a learning target of classifier based on a selection probability of each variable combination and the target number of variable combinations to be dropped,
wherein the learning of the classifier provides the probability value of each variable combination corresponding to the variable combination to the classifier.

15. The processing method of claim 12, wherein, in the appearance frequency extraction operation, a probability distribution of the appearance frequency of each variable combination is derived from the data, and
in the confidence-based smoothing operation, the frequency matrix is generated based on the probability distribution.

16. The preprocessing method of claim 12, wherein, in the confidence-based smoothing operation, a Laplace smoothing parameter is calculated based on the cumulative appearance frequency and a critical appearance frequency, and the probability value of each variable combination is calculated by applying Laplace smoothing to the frequency matrix according to the Laplace smoothing parameter.

17. The preprocessing method of claim 14, wherein, in the variable selection probability calculation operation, the selection probability of each variable combination is calculated based on a reciprocal of the cumulative appearance frequency.
